(19) United States
(12) Patent Application Publication
(10) Pub. No.: US 2025/0370785 A1
(43) Pub. Date: Dec. 4, 2025

(54) METHODS AND COMPUTING DEVICES FOR ACCESSING TPM IN A COMPUTING DEVICE

(71) Applicant: Alipay (Hangzhou) Information Technology Co., Ltd., Hangzhou (CN)

(72) Inventors: Shuang LIU, Hangzhou (CN); Zhou CHEN, Hangzhou (CN); Xufeng ZHANG, Hangzhou (CN); Shoumeng YAN, Hangzhou (CN)

(73) Assignee: Alipay (Hangzhou) Information Technology Co., Ltd., Hangzhou (CN)

(21) Appl. No.: 19/301,061

(22) Filed: Aug. 15, 2025

Related U.S. Application Data
(63) Continuation of application No. PCT/CN2024/085820, filed on Apr. 3, 2024.

(30) Foreign Application Priority Data
Apr. 4, 2023 (CN) 202310376985.7

(51) Int. Cl. G06F 9/455

(52) U.S. Cl. CPC G06F 9/45558; G06F 2009/45587; G06F 2009/45591

(57) ABSTRACT

Methods and apparatuses for accessing a trusted platform module (TPM) are disclosed. In an implementation, a method comprises receiving, by a virtual machine monitor from a first virtual machine in at least one virtual machine, a first notification message for requesting to access the TPM. In response to determining that the TPM is unlocked, locking, by the virtual machine monitor, the TPM to allow the TPM to be accessed only by the first virtual machine, and sending a first decision message to the first virtual machine indicating the first virtual machine to start performing a first access operation on the TPM. Receiving, by the virtual machine monitor, a second notification message from the first virtual machine, and unlocking, by the virtual machine monitor, the TPM in response to the second notification message.

### CROSS-REFERENCE TO RELATED APPLICATIONS

This application is a continuation of PCT Application No. PCT/CN2024/085820, filed on Apr. 3, 2024, which claims priority to Chinese Patent Application No. 202310376985.7, filed on Apr. 4, 2023, and each application is hereby incorporated by reference in its entirety.

### TECHNICAL FIELD

One or more embodiments of this specification relate to the computer field, and in particular, to methods and computing devices for accessing a trusted platform module (TPM) in a computing device.

### BACKGROUND

A TPM can be used as a hardware root of trust, to securely record a start-time state of a key startup module in a computing device and record a run-time state of a core functional module in the computing device. The TPM has been widely applied to a virtualization technology solution including a virtual machine (VM) and a virtual machine monitor (VMM, which is alternatively referred to as a hypervisor), to enhance the security of the virtual machine and the virtual machine monitor.

A new technical solution is desired to ensure that the virtual machine monitor and at least one virtual machine deployed in the computing device can access the TPM serially, while improving the efficiency of the virtual machine's access to the TPM.

### SUMMARY

One or more embodiments of this specification provide methods for accessing a TPM in a computing device and corresponding computing devices capable of ensuring that the virtual machine monitor and at least one virtual machine can access the TPM serially, while improving the efficiency of the virtual machine's access to the TPM.

According to a first aspect, a method for accessing a TPM in a computing device is provided, and a virtual machine monitor and at least one virtual machine are deployed in the computing device. The method includes: receiving, by the virtual machine monitor from a first virtual machine in the at least one virtual machine, a first notification message for requesting to access the TPM; determining, by the virtual machine monitor in response to the first notification message, whether the TPM is locked; if the TPM is unlocked, locking, by the virtual machine monitor, the TPM, so that the TPM is allowed to be accessed only by the first virtual machine, and returning a first decision message to the first virtual machine, so that the first virtual machine starts to perform a first access operation on the TPM; receiving, by the virtual machine monitor, a second notification message from the first virtual machine, where the second notification message is initiated by the first virtual machine after completing the first access operation; and unlocking, by the virtual machine monitor, the TPM in response to the second notification message.

In a possible implementation, the method further includes: determining, by the virtual machine monitor before starting to access the TPM, whether the TPM is locked; locking, by the virtual machine monitor, the TPM if the TPM is unlocked, so that the TPM is allowed to be accessed only by the virtual machine monitor; accessing, by the virtual machine monitor, the TPM; and unlocking, by the virtual machine monitor, the TPM after completing accessing the TPM.

In a possible implementation, the virtual machine monitor is configured with a state machine corresponding to the TPM, a current state of the state machine includes a first state or a second state, the first state is used to indicate that the TPM is locked, and the second state is used to indicate that the TPM is unlocked; where the locking the TPM includes: setting the current state of the state machine to the first state; and the unlocking the TPM includes: setting the current state of the state machine to the second state.

In a possible implementation, the first virtual machine is configured with a TPM native driver and a TPM proxy driver, and the method further includes: obtaining, by the TPM proxy driver, an access request for the TPM, and providing the first notification message to the virtual machine monitor based on the access request, where the access request is initiated by a first application in the first virtual machine; providing, by the TPM proxy driver, the access request to the TPM native driver in response to the first decision message received from the virtual machine monitor; performing, by the TPM native driver, the first access operation based on the access request; and providing, by the TPM proxy driver, the second notification message to the virtual machine monitor after the TPM native driver completes the first access operation.

In a possible implementation, the obtaining, by the TPM proxy driver, an access request for the TPM includes: obtaining, by the TPM proxy driver by intercepting a target access method used in the TPM native driver to access the TPM, the access request initiated by the first application by calling the target access method.

According to a second aspect, a computing device is provided. A virtual machine monitor and at least one virtual machine are deployed in the computing device, and the virtual machine monitor includes: a message receiving unit, configured to receive, from a first virtual machine in the at least one virtual machine, a first notification message for requesting to access a TPM; a state management unit, configured to determine, in response to the first notification message, whether the TPM is locked, where the state management unit is further configured to lock the TPM if the TPM is unlocked, so that the TPM is allowed to be accessed only by the first virtual machine; and a message sending unit, configured to return a first decision message to the first virtual machine if the TPM is unlocked, so that the first virtual machine starts to perform a first access operation on the TPM, where the message receiving unit is further configured to receive a second notification message from the first virtual machine, and the second notification message is initiated by the first virtual machine after completing the first access operation; and the state management unit is further configured to unlock the TPM in response to the second notification message.

In a possible implementation, the virtual machine monitor further includes an access management unit, where the state management unit is further configured to determine, before the virtual machine monitor starts to access the TPM, whether the TPM is locked; the state management unit is further configured to lock the TPM if the TPM is unlocked, so that the TPM is allowed to be accessed only by the virtual machine monitor; the access management unit is configured to access the TPM; and the state management unit is further configured to unlock the TPM after the virtual machine monitor completes accessing the TPM.

In a possible implementation, the virtual machine monitor is configured with a state machine corresponding to the TPM, a current state of the state machine includes a first state or a second state, the first state is used to indicate that the TPM is locked, and the second state is used to indicate that the TPM is unlocked; the state management unit is specifically configured to set the current state of the state machine to the first state; and the state management unit is specifically configured to set the current state of the state machine to the second state.

In a possible implementation, the first virtual machine is configured with a TPM native driver and a TPM proxy driver; the TPM proxy driver is configured to obtain an access request for the TPM, and provide the first notification message to the virtual machine monitor based on the access request, where the access request is initiated by a first application in the first virtual machine; the TPM proxy driver is further configured to provide the access request to the TPM native driver in response to the first decision message received from the virtual machine monitor; the TPM native driver is configured to perform the first access operation based on the access request; and the TPM proxy driver is further configured to provide the second notification message to the virtual machine monitor after the TPM native driver completes the first access operation.

In a possible implementation, the TPM proxy driver is specifically configured to obtain, by intercepting a target access method used in the TPM native driver to access the TPM, the access request initiated by the first application by calling the target access method.

According to the methods and the computing devices provided in one or more embodiments of this specification, if a first virtual machine in at least one virtual machine expects to access a TPM, the first virtual machine can correspondingly provide, to the virtual machine monitor, a first notification message for requesting to access the TPM; the virtual machine monitor can determine, in response to the first notification message, whether the TPM is locked, and lock the TPM if the TPM is unlocked, so that the TPM is allowed to be accessed only by the first virtual machine, and the virtual machine monitor can return a first decision message to the first virtual machine; the first virtual machine can start to perform a first access operation on the TPM in response to the first decision information, and provide a second notification message to the virtual machine monitor after completing the first access operation; and the virtual machine monitor can unlock the TPM in response to the second notification message. Thus, while the virtual machine monitor and the at least one virtual machine deployed in the computing device can access the TPM serially, the virtual machine can access the TPM directly without being trapped into the virtual machine monitor, thereby enabling more efficient access to the TPM. In addition, the virtual machine monitor does not need to emulate all functions of the TPM, resulting in a simpler implementation, higher execution efficiency, and no negative impact on the security of the VMM.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of the present invention, and a person of ordinary skill in the art can still derive other drawings from these accompanying drawings without creative efforts.

FIG. 1 is a first schematic diagram illustrating a structure of a computing device, according to embodiments of this specification;

FIG. 2 is a first example flowchart illustrating a method for accessing a TPM in a computing device;

FIG. 3 is a second example flowchart illustrating a method for accessing a TPM in a computing device; and

FIG. 4 is a second schematic diagram illustrating a structure of a computing device, according to embodiments of this specification.

### DETAILED DESCRIPTION

The non-limiting embodiments provided in this specification are described below in detail with reference to the accompanying drawings.

A TPM is a system component in a computing device that is isolated from a host system, and interacts with the host system of the computing device based on a standard specification interface. The TPM can be a secure microcontroller with an encryption function, and is intended to provide a basic security function related to an encryption and decryption key, and is generally implemented based on a TPM that provides a dedicated physical resource. For example, the TPM can be implemented as a single independent TPM chip, or can be implemented as a permanently independent TPM calculation unit or a temporarily allocated TPM calculation unit in a processor in some technical scenarios. As a core component of the trusted computing platform, the TPM chip is a system-level chip that includes a plurality of functional components, such as a password computation component and a storage component. Generally, the TPM chip is integrated on a mainboard of the computing device, and communicates with another functional component in the computing device through a hardware bus of the computing device.

The TPM can generate a key, store and authenticate the key, encrypt and restore data at a high speed, etc. As an auxiliary processor that protects a basic input/output system (BIOS) and an operating system (OS) in the computing device from being modified, the TPM can construct a trusted computing architecture across a platform and a software/hardware system by using a combination of a trusted computing group (TCG) software stack (TSS) and the TPM. On this basis, based on various possible TPMs including the TPM chip, a secure application used to implement various phases such as unique identity identification, system login encryption, folder encryption, and network communication encryption can be developed. The secure application implements related functions by accessing the TPM.

The TPM has been widely applied to a virtualization technology solution, and the security of a virtual machine (including an application or another core functional module in the virtual machine) and a virtual machine monitor (including a core functional module in the virtual machine monitor) deployed in the computing device is enhanced through the TPM. More specifically, the TPM can be used as a hardware root of trust of the computing device, to securely record a start-time state of a key startup module in the computing device and record a run-time state of a core functional module in the computing device, so as to ensure the security of a related module at a startup phase and a running phase. The TCG specification requires serial access to the TPM in the computing device. In other words, when both the virtual machine monitor and at least one virtual machine are deployed in the computing device, it is required to ensure that the virtual machine monitor and the at least one virtual machine can access a related TPM serially.

In a possible implementation, a function of the TPM can be emulated by using the virtual machine monitor, and a virtual TPM that is allowed to be accessed by the virtual machine can be provided to the virtual machine. When the virtual machine requests to access the TPM, the virtual machine can be trapped in the virtual machine monitor by accessing the virtual TPM. The virtual machine monitor obtains an access request for the TPM through the virtual TPM, and then correspondingly accesses the TPM. From the perspective of the virtual machine monitor, different virtual machines correspond to different TPM applications in the computing device, and the virtual machine monitor can ensure, by using a TSS protocol stack, that the virtual machine monitor and the TPM application access the TPM serially. However, the TPM has complex functions, and if a function of the TPM is emulated by using the virtual machine monitor, implementation complexity is increased, and trusted computing bases (TCB) of the virtual machine monitor are significantly increased, and further, more attack aspects are introduced to the virtual machine monitor, and consequently, the security of the virtual machine monitor is reduced. In addition, when the virtual machine requests to access the virtual TPM, the virtual machine exits and is trapped into the virtual machine monitor. Due to high complexity and low performance of this process, it is difficult to support the virtual machine to efficiently access the TPM.

Embodiments of this specification provide methods for accessing a TPM in a computing device and computing devices. A virtual machine monitor and at least one virtual machine are deployed in the computing device. If a first virtual machine in the at least one virtual machine expects to access a TPM, the first virtual machine can correspondingly provide, to the virtual machine monitor, a first notification message for requesting to access the TPM; the virtual machine monitor can determine, in response to the first notification message, whether the TPM is locked, and lock the TPM if the TPM is unlocked, so that the TPM is allowed to be accessed only by the first virtual machine, and the virtual machine monitor can return a first decision message to the first virtual machine; the first virtual machine can start to perform a first access operation on the TPM in response to the first decision information, and provide a second notification message to the virtual machine monitor after completing the first access operation; and the virtual machine monitor can unlock the TPM in response to the second notification message. Thus, while the virtual machine monitor and the at least one virtual machine deployed in the computing device can access the TPM serially, the virtual machine can access the TPM directly without being trapped into the virtual machine monitor, thereby enabling more efficient access to the TPM. In addition, the virtual machine monitor does not need to emulate all functions of the TPM, resulting in a simpler implementation, higher execution efficiency, and no negative impact on the security of the VMM.

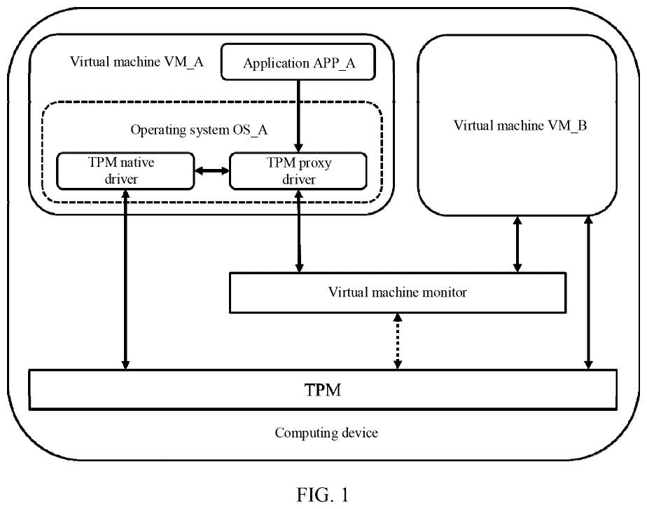

FIG. 1 is a first schematic diagram illustrating a structure of a computing device, according to some embodiments of this specification. As shown in FIG. 1, the computing device includes a TPM that is used as independent hardware. It can be understood that the computing device can further include functional components that are communicatively connected to the TPM through a hardware bus, such as a memory and a processor. A virtual machine monitor and at least one virtual machine created/managed by the virtual machine monitor are deployed in the computing device, for example, a virtual machine VM_A and a virtual machine VM_B that are managed by the virtual machine monitor are deployed. The virtual machine monitor and the at least one virtual machine created/managed by the virtual machine monitor can both access the TPM on demand, and it is required to ensure that the virtual machine monitor and the at least one virtual machine allow only serial access to the TPM.

As an example for description, the virtual machine VM_A is used as a first virtual machine that may access the TPM. The virtual machine VM_A includes an operating system OS_A and a secure application APP_A that relies on the operating system OS_A to run. The secure application APP_A can initiate an access request for the TPM, thereby implementing related tasks with the help of the TPM, for example, implementing functions such as identity identification, system login encryption, folder encryption, and network communication encryption.

The inventors find after research that after the operating system loads a TPM native driver corresponding to the TPM, and registers a chip operation method corresponding to the TPM with the operating system. The chip operation method refers to a target access method used to access the TPM. Then, related information of the TPM is exported to user space, so that a user-mode application that relies on the operating system to run can initiate the access request for the TPM by calling the target access method. For example, in a Linux operating system, when an application expects to access the TPM, a method function tpm_try_transmit( ) needs to be called to send all TPM commands (that is, access requests) to the TPM. In tpm_try_transmit( ) a registered chip operation method ops needs to be called. In this process, chip->ops.clk_enable( ) is always called first to enable a TPM clock, and then chip->ops.clk_enable is called again to disable the TPM clock.

Based on the above-mentioned discovery, after the virtual machine monitor is started and the virtual machine managed by the virtual machine monitor is loaded with the TPM native driver, an operating system of the virtual machine can further load a TPM proxy driver, and intercept, by using the TPM proxy driver, a target access method used in the TPM native driver to access the TPM, so that when an application in the user space requests to access the TPM, the TPM proxy driver is always accessed first. Thus, through cooperation of the TPM proxy driver, the TPM native driver, and the virtual machine monitor, the virtual machine is supported to efficiently access the TPM while it is ensured that the virtual machine monitor and the at least one virtual machine that are deployed in the computing device can access the TPM serially. Functions of the TPM proxy driver are described in detail below.

A process in which the virtual machine and the virtual machine monitor access the TPM is described in detail below with reference to the computing device shown in FIG. 1.

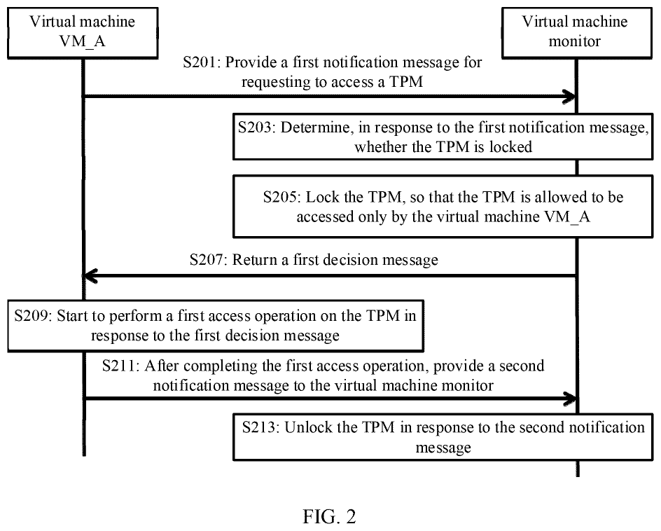

FIG. 2 is a first example flowchart illustrating a method for accessing a TPM in a computing device. The computing device includes a virtual machine monitor and at least one virtual machine managed/created by the virtual machine monitor. A process of any first virtual machine (virtual machine VM_A) in the computing device is described in this method as an example.

As shown in FIG. 2, the method can include but is not limited to some or all of the following step S201 to step S09.

Step S201: The virtual machine VM_A provides, to the virtual machine monitor, a first notification message for requesting to access a TPM.

When the virtual machine VM_A has been loaded with a TPM proxy driver and a TPM native driver, a first application (for example, APP_A) in the virtual machine VM_A that requests to access the TPM can initiate an access request for the TPM, and the access request can be sent to the TPM proxy driver, so that the TPM proxy driver provides, to the virtual machine monitor based on the access request received by the TPM proxy driver, the first notification message for requesting to access the TPM. In a possible implementation, the TPM proxy driver can obtain, by intercepting a target access method used in the TPM native driver to access the TPM, an access request initiated by APP_A by calling the target access method. In another possible implementation, a kernel code in an operating system OS_A of the virtual machine VM_A that is used to support an application to access the TPM native driver can be modified, so that APP_A can directly send the access request for the TPM to the TPM proxy driver.

Step S203: The virtual machine monitor determines, in response to the first notification message, whether the TPM is locked.

If the TPM is locked, it indicates that the virtual machine or the virtual machine monitor is accessing the TPM. If the TPM is unlocked, it indicates that no virtual machine or virtual machine monitor is currently accessing the TPM. The virtual machine monitor can lock the TPM and unlock the TPM by using an implementation such as a state machine or a mutex lock.

In the following description, a state machine is used in the virtual machine monitor as an example for description.

The virtual machine monitor can maintain a state machine corresponding to the TPM. A current state of the state machine can include a first state or a second state. The first state is used to indicate that the TPM is locked, and the second state is used to indicate that the TPM is unlocked. Correspondingly, the virtual machine monitor can determine, by querying the current state of the state machine, whether the TPM is locked, that is, determine whether the virtual machine or the virtual machine monitor is currently accessing the TPM.

If the TPM is unlocked, the virtual machine monitor can continue to perform subsequent steps including step S205. If the TPM is locked, the virtual machine monitor can control the following operation by using, for example, a message queue: after a virtual machine or the virtual machine monitor that first requests to access the TPM completes accessing the TPM, subsequent steps including step S205 are correspondingly performed for the virtual machine VM_A; or the virtual machine monitor can return, to the virtual machine VM_A, a second decision message indicating that there is another virtual machine or virtual machine monitor that is currently accessing the TPM, so that the virtual machine VM_A initiates the first notification message again or stops requesting to access the TPM based on a corresponding policy.

Step S205: The virtual machine monitor locks the TPM, so that the TPM is allowed to be accessed only by the virtual machine VM_A.

For example, the virtual machine monitor can set the current state of the state machine from the second state to the first state.

Step S207: The virtual machine monitor returns a first decision message to the virtual machine VM_A.

Step S209: The virtual machine VM_A starts a first access operation on the TPM in response to the first decision message.

When the virtual machine VM_A has been loaded with the TPM proxy driver and the TPM native driver, the first decision message returned by the virtual machine monitor can, for example, be received by the TPM proxy driver. The TPM proxy driver provides, to the TPM native driver in response to the first decision message received by the TPM proxy driver from the virtual machine monitor, an access request received by the TPM proxy driver from the application APP_A. Further, the TPM native driver implements the first access operation on the TPM based on the access request.

Step S211: After completing the first access operation, the virtual machine VM_A provides a second notification message to the virtual machine monitor.

When the virtual machine VM_A has been loaded with the TPM proxy driver and the TPM native driver, after the TPM native driver completes the first access operation on the TPM, the TPM proxy driver provides, to the virtual machine monitor, the second notification message for requesting the virtual machine monitor to unlock the TPM.

Step S213: The virtual machine monitor unlocks the TPM in response to the second notification message.

For example, the virtual machine monitor can set the current state of the state machine from the first state to the second state.

A process in which the virtual machine VM_A accesses the TPM when the virtual machine VM_A is configured with the TPM native driver and the TPM proxy driver is described above. However, it can be understood that the virtual machine VM_A can also implement, with the support from another functional module, a function that needs to be implemented by the virtual machine VM_A in the method embodiment shown in FIG. 2. For example, the virtual machine VM_A does not need to be loaded with the TPM native driver and the TPM proxy driver, but is loaded with a TPM driver that is rewritten by the staff, and completes, with the support from the TPM driver, transactions originally completed by the TPM native driver and the TPM proxy driver.

A process in which the virtual machine in the computing device accesses the TPM efficiently with the support from the virtual machine monitor is described in detail in the above-mentioned method embodiment shown in FIG. 2. However, in some technical scenarios, the virtual machine monitor can also use the TPM as required. A process in which the virtual machine monitor accesses the TPM is described below.

As shown in FIG. 3, the method can include but is not limited to some or all of the following step S301 to step S307.

Step S301: Before starting to access a TPM, a virtual machine monitor determines whether the TPM is locked.

If the TPM is locked, it indicates that a virtual machine or the virtual machine monitor is accessing the TPM. If the TPM is unlocked, it indicates that no virtual machine or virtual machine monitor is currently accessing the TPM. The virtual machine monitor can lock the TPM and unlock the TPM by using an implementation such as a state machine or a mutex lock.

For example, the virtual machine monitor uses a state machine. The virtual machine monitor can determine, by querying a current state of the state machine, whether the TPM is locked, that is, determine whether the virtual machine or the virtual machine monitor is accessing the TPM.

If the TPM is unlocked, the virtual machine monitor can continue to perform subsequent steps including step S305. If the TPM is locked, the virtual machine monitor can wait, for example, for the TPM to be unlocked, and then correspondingly perform subsequent steps including step S303 for the virtual machine.

Step S303: If the TPM is unlocked, the virtual machine monitor locks the TPM, so that the TPM is allowed to be accessed only by the virtual machine monitor.

For example, the virtual machine monitor can set the current state of the state machine from the second state to the first state.

Step S305: The virtual machine monitor starts to access the TPM.

Step S306: After completing accessing the TPM, the virtual machine monitor unlocks the TPM.

For example, the virtual machine monitor can set the current state of the state machine from the first state to the second state.

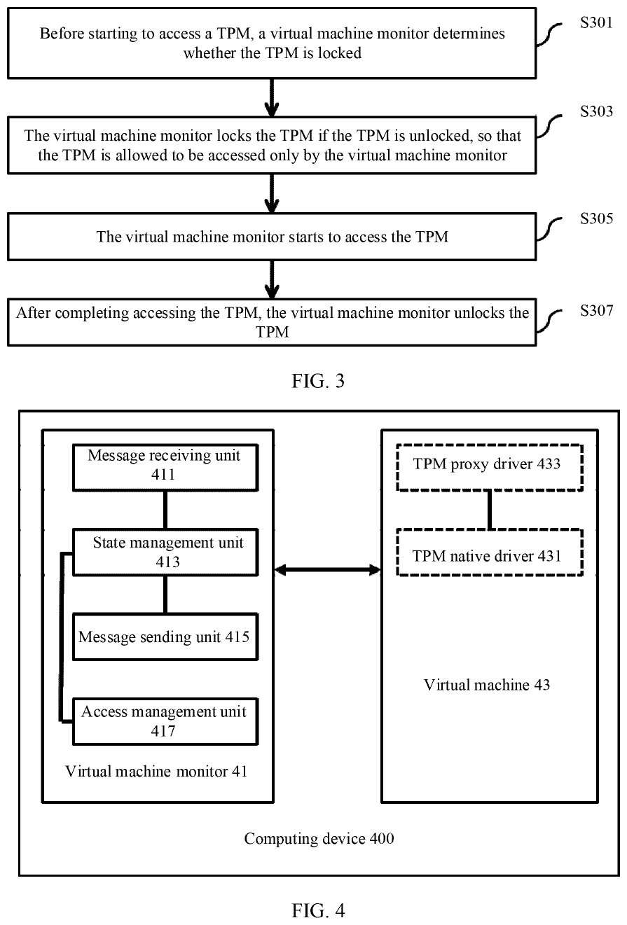

Based on the same concept as the above-mentioned method embodiments, some embodiments of this specification further provide a computing device 400. As shown in FIG. 4, a virtual machine monitor 41 and at least one virtual machine 43 are deployed in the computing device. The virtual machine monitor 41 includes: a message receiving unit 411, configured to receive, from a first virtual machine 43 in the at least one virtual machine 43, a first notification message for requesting to access a TPM; a state management unit 413, configured to determine, in response to the first notification message, whether the TPM is locked, where the state management unit 413 is further configured to lock the TPM if the TPM is unlocked, so that the TPM is allowed to be accessed only by the first virtual machine; and a message sending unit 415, configured to return a first decision message to the first virtual machine if the TPM is unlocked, so that the first virtual machine starts to perform a first access operation on the TPM, where the message receiving unit 411 is further configured to receive a second notification message from the first virtual machine, and the second notification message is initiated by the first virtual machine after completing the first access operation; and the state management unit 413 is further configured to unlock the TPM in response to the second notification message.

In a possible implementation, the virtual machine monitor 41 further includes an access management unit 417, where the state management unit 413 is further configured to determine, before the virtual machine monitor starts to access the TPM, whether the TPM is locked; the state management unit 413 is further configured to lock the TPM if the TPM is unlocked, so that the TPM is allowed to be accessed only by the virtual machine monitor; the access management unit 417 is configured to access the TPM; and the state management unit 413 is further configured to unlock the TPM after the virtual machine monitor completes accessing the TPM.

In a possible implementation, the virtual machine monitor 41 is configured with a state machine corresponding to the TPM, a current state of the state machine includes a first state or a second state, the first state is used to indicate that the TPM is locked, and the second state is used to indicate that the TPM is unlocked; the state management unit 413 is specifically configured to set the current state of the state machine to the first state; and the state management unit 413 is specifically configured to set the current state of the state machine to the second state.

In a possible implementation, the first virtual machine 43 is configured with a TPM native driver 431 and a TPM proxy driver 433; the TPM proxy driver 433 is configured to obtain an access request for the TPM, and provide the first notification message to the virtual machine monitor based on the access request, where the access request is initiated by a first application in the first virtual machine; the TPM proxy driver 433 is further configured to provide the access request to the TPM native driver 431 in response to the first decision message received from the virtual machine monitor 41; the TPM native driver 431 is configured to perform the first access operation based on the access request; and the TPM proxy driver 433 is further configured to provide the second notification message to the virtual machine monitor after the TPM native driver completes the first access operation.

In a possible implementation, the TPM proxy driver 433 is specifically configured to obtain, by intercepting a target access method used in the TPM native driver 431 to access the TPM, the access request initiated by the first application by calling the target access method.

A person skilled in the art should be aware that in the above-mentioned one or more examples, functions described in the this specification can be implemented by hardware, software, firmware, or any combination thereof. When the functions are implemented by software, computer programs corresponding to these functions can be stored in a computer-readable medium or transmitted as one or more instructions/code in the computer-readable medium, so that when the computer programs corresponding to these functions are executed by a computer, the method in any one of the embodiments of this specification is implemented by the computer.

Embodiments of the specification further provide a computer-readable storage medium. The computer-readable storage medium stores a computer program, and when the computer program is executed in a computing device, the method for accessing a TPM in a computing device provided in any one of the embodiments of this specification is implemented.

Embodiments of the specification further provide a computing device, including a memory and a processor. The memory stores executable code, and when the processor executes the executable code, the method for accessing a TPM in a computing device provided in any one of the embodiments of this specification is implemented.

The embodiments of this specification all are described in a progressive way. For same or similar parts of the embodiments, mutual references can be made to the embodiments. Each embodiment focuses on a difference from other embodiments. Particularly, the apparatus embodiments are briefly described since they are basically similar to the method embodiments. For related parts, references can be made to related descriptions in the method embodiments.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing are feasible or may be advantageous.

In the above specific implementations, the objectives, technical solutions, and beneficial effects of the present invention are further described in detail. It should be understood that the above descriptions are merely specific implementations of the present invention, but are not intended to limit the protection scope of the present invention. Any modification, equivalent replacement, improvement, or the like made based on the technical solutions of the present invention shall fall within the protection scope of the present invention.

1. A method for accessing a trusted platform module (TPM) in a computing device, wherein the computing device comprises a virtual machine monitor and at least one virtual machine, and wherein the method comprises:
receiving, by the virtual machine monitor from a first virtual machine in the at least one virtual machine, a first notification message for requesting to access the TPM;
in response to the first notification message, determining, by the virtual machine monitor, whether the TPM is locked or unlocked;
in response to determining that the TPM is unlocked:
locking, by the virtual machine monitor, the TPM to allow the TPM to be accessed only by the first virtual machine; and
sending a first decision message to the first virtual machine indicating the first virtual machine to start performing a first access operation on the TPM;
receiving, by the virtual machine monitor, a second notification message from the first virtual machine, wherein the second notification message is initiated by the first virtual machine after completing the first access operation; and
unlocking, by the virtual machine monitor, the TPM in response to the second notification message.

2. The method according to claim 1, wherein the method further comprises:
after unlocking the TPM, locking, by the virtual machine monitor, the TPM, so that the TPM is allowed to be accessed only by the virtual machine monitor;
accessing, by the virtual machine monitor, the TPM; and
unlocking, by the virtual machine monitor, the TPM after completing accessing the TPM.

3. The method according to claim 1, wherein the virtual machine monitor is configured with a state machine corresponding to the TPM, a current state of the state machine comprises a first state indicating that the TPM is locked or a second state indicating that the TPM is unlocked;
wherein the locking the TPM comprises setting the current state of the state machine to the first state; and
wherein the unlocking the TPM comprises setting the current state of the state machine to the second state.

4. The method according to claim 1, wherein the first virtual machine is configured with a TPM native driver and a TPM proxy driver, and wherein the method further comprises:
obtaining, by the TPM proxy driver, an access request for the TPM;
providing the first notification message to the virtual machine monitor based on the access request, wherein the access request is initiated by a first application in the first virtual machine;
providing, by the TPM proxy driver, the access request to the TPM native driver in response to the first decision message received from the virtual machine monitor;
performing, by the TPM native driver, the first access operation based on the access request; and
providing, by the TPM proxy driver, the second notification message to the virtual machine monitor after the TPM native driver completes the first access operation.

5. The method according to claim 4, wherein the obtaining, by the TPM proxy driver, an access request for the TPM comprises:
obtaining, by the TPM proxy driver by intercepting a target access method used in the TPM native driver to access the TPM, wherein the access request is initiated by the first application by calling the target access method.

6. A computing device, comprising:
at least one processor; and
one or more memories coupled to the at least one processor and storing programming instructions for execution by the at least one processor to perform operations comprising:
receiving, by a virtual machine monitor from a first virtual machine in at least one virtual machine, a first notification message for requesting to access a trusted platform module (TPM), wherein the virtual machine monitor and the at least one virtual machine are deployed in the computing device;
in response to the first notification message, determining, by the virtual machine monitor, whether the TPM is locked or unlocked;
in response to determining that the TPM is unlocked:
locking, by the virtual machine monitor, the TPM to allow the TPM to be accessed only by the first virtual machine; and
sending a first decision message to the first virtual machine indicating the first virtual machine to start performing a first access operation on the TPM;
receiving, by the virtual machine monitor, a second notification message from the first virtual machine, wherein the second notification message is initiated by the first virtual machine after completing the first access operation; and
unlocking, by the virtual machine monitor, the TPM in response to the second notification message.

7. The computing device according to claim 6, wherein the operations further comprise:
after unlocking the TPM, locking, by the virtual machine monitor, the TPM, so that the TPM is allowed to be accessed only by the virtual machine monitor;
accessing, by the virtual machine monitor, the TPM; and
unlocking, by the virtual machine monitor, the TPM after completing accessing the TPM.

8. The computing device according to claim 6, wherein the virtual machine monitor is configured with a state machine corresponding to the TPM, a current state of the state machine comprises a first state indicating that the TPM is locked or a second state indicating that the TPM is unlocked;
wherein the locking the TPM comprises setting the current state of the state machine to the first state; and
wherein the unlocking the TPM comprises setting the current state of the state machine to the second state.

9. The computing device according to claim 6, wherein the first virtual machine is configured with a TPM native driver and a TPM proxy driver, and wherein the operations further comprise:
obtaining, by the TPM proxy driver, an access request for the TPM;
providing the first notification message to the virtual machine monitor based on the access request, wherein the access request is initiated by a first application in the first virtual machine;
providing, by the TPM proxy driver, the access request to the TPM native driver in response to the first decision message received from the virtual machine monitor;
performing, by the TPM native driver, the first access operation based on the access request; and
providing, by the TPM proxy driver, the second notification message to the virtual machine monitor after the TPM native driver completes the first access operation.

10. The computing device according to claim 9, wherein the obtaining, by the TPM proxy driver, an access request for the TPM comprises:
obtaining, by the TPM proxy driver by intercepting a target access method used in the TPM native driver to access the TPM, wherein the access request is initiated by the first application by calling the target access method.

11. A non-transitory, computer-readable medium storing one or more instructions executable by at least one processor to perform operations comprising:
receiving, by a virtual machine monitor from a first virtual machine in at least one virtual machine, a first notification message for requesting to access a trusted platform module (TPM), wherein the virtual machine monitor and the at least one virtual machine are deployed in a computing device;
in response to the first notification message, determining, by the virtual machine monitor, whether the TPM is locked or unlocked;
in response to determining that the TPM is unlocked:
locking, by the virtual machine monitor, the TPM to allow the TPM to be accessed only by the first virtual machine; and
sending a first decision message to the first virtual machine indicating the first virtual machine to start performing a first access operation on the TPM;
receiving, by the virtual machine monitor, a second notification message from the first virtual machine, wherein the second notification message is initiated by the first virtual machine after completing the first access operation; and
unlocking, by the virtual machine monitor, the TPM in response to the second notification message.

12. The non-transitory, computer-readable medium according to claim 11, wherein the operations further comprise:
after unlocking the TPM, locking, by the virtual machine monitor, the TPM, so that the TPM is allowed to be accessed only by the virtual machine monitor;
accessing, by the virtual machine monitor, the TPM; and
unlocking, by the virtual machine monitor, the TPM after completing accessing the TPM.

13. The non-transitory, computer-readable medium according to claim 11, wherein the virtual machine monitor is configured with a state machine corresponding to the TPM, a current state of the state machine comprises a first state indicating that the TPM is locked or a second state indicating that the TPM is unlocked;
wherein the locking the TPM comprises setting the current state of the state machine to the first state; and
wherein the unlocking the TPM comprises setting the current state of the state machine to the second state.

14. The non-transitory, computer-readable medium according to claim 11, wherein the first virtual machine is configured with a TPM native driver and a TPM proxy driver, and wherein the operations further comprise:
obtaining, by the TPM proxy driver, an access request for the TPM;
providing the first notification message to the virtual machine monitor based on the access request, wherein the access request is initiated by a first application in the first virtual machine;
providing, by the TPM proxy driver, the access request to the TPM native driver in response to the first decision message received from the virtual machine monitor;
performing, by the TPM native driver, the first access operation based on the access request; and
providing, by the TPM proxy driver, the second notification message to the virtual machine monitor after the TPM native driver completes the first access operation.

15. The non-transitory, computer-readable medium according to claim 14, wherein the obtaining, by the TPM proxy driver, an access request for the TPM comprises:
obtaining, by the TPM proxy driver by intercepting a target access method used in the TPM native driver to access the TPM, wherein the access request is initiated by the first application by calling the target access method.
